(19) United States
(12) Patent Application Publication
(10) Pub. No.: US 2016/0339732 A1
(43) Pub. Date: Nov. 24, 2016

(54) CALENDAR HOLDER

(71) Applicant: Betsy A. McALPINE, Ellsworth, ME (US)

(72) Inventor: Betsy A. McALPINE, Ellsworth, ME (US)

(21) Appl. No.: 14/813,947

(22) Filed: Jul. 30, 2015

Related U.S. Application Data
(60) Provisional application No. 62/033,139, filed on Aug. 5, 2014.

(51) Int. Cl. B42D 5/04; F16B 2/10; F16M 13/02

(52) U.S. Cl. CPC B42D 5/046; F16M 13/02; F16B 2/10

(57) ABSTRACT

A calendar holder and methods of use, with the calendar holder having a pair of horizontally oriented jaws of substantially the same width as the width of a calendar page, with the jaws suitable adapted to retain the top edge of the calendar therebetween, and with an attachment component located on the rear of the device suitable for securing the device and a retained calendar to a wall, and with a frontal design element which provides an aesthetically pleasing look to the device while obscuring substantially all portions of the jaws of the device.

### CROSS REFERENCE TO RELATED APPLICATIONS

This application claims priority to a provisional application, U.S. Ser. No. 62/033,139, filed Aug. 5, 2014, entitled Calendar Holder, by McAlpine, Betsy A., which is hereby incorporated by reference.

### BACKGROUND

Wall calendars, of the sort constructed of multiple pages having a horizontal fold, with a photograph or other artwork above the horizontal fold and a month worth of days below the fold, are very popular. Each new month the lower calendar portion is folded up, revealing a new photograph or artwork on its reverse side and a new month below the fold. Such calendars are typically attached to a wall or other vertical surface by a fastening device, such as a nail or thumb tack, which is passed through the top of the calendar, either through a pre-formed hole located at the top of the page or through the page itself.

Unfortunately, though the traditional fastening devices tend to work well in securing the calendar to the wall, they often fail to maintain the upper portion of the calendar containing the photograph or artwork in a proper state for viewing. That is, because the fastening device is typically centered on the top edge of the calendar at a single point, the upper corners of the calendar have no support and tend to curl forward and downward toward the center. This obscures portions of the photograph or artwork and gives an unpleasant appearance to the calendar. Less expensive calendars using lighter weight paper tend to be more prone to this curling effect.

In addition, where the calendar does not have a pre-formed hole, but instead the fastening device must be passed through the page itself, each time the calendar is flipped to expose the next month a new hole is made. Because the page being folded up obscures the previous hole, it is very difficult to perfectly align the new hole with the previous hole. This results often times in multiple holes being made through the calendar, as well as into the wall, potentially damaging both.

Finally, the fastening device is typically not very aesthetically pleasing, being a simple nail or thumb tack. While some thumb tacks have colored heads, they add little to the overall appearance of the calendar, and often detract therefrom.

It is therefore evident that an improved means for attaching a calendar to a wall is needed.

It is thus an object of the present invention to present a device for attaching a calendar to a wall which is capable of holding the upper pages of the calendar flat, without the curling of upper corners or edges.

It is a further object of the present invention to present a device for attaching a calendar to a wall which does not require multiple holes to be made in the calendar or wall.

It is yet a further object of the present invention to present a device for attaching a calendar to a wall which is easy to use.

It is yet a further object of the present invention to present a device for attaching a calendar to a wall which is aesthetically pleasing and enhances the overall appearance of the calendar.

It is yet a further object of the present invention to present a device for attaching a calendar to a wall which is inexpensive to manufacture.

It is yet a further object of the present invention to present a method for using a device for attaching a calendar to a wall.

Other objectives of the present invention will be readily apparent from the description that follows.

### SUMMARY

The device of the present invention is intended to provide an inexpensive, aesthetically pleasing, easy to use clip for retaining a calendar to a wall in a manner which prevents the calendar pages from curling forward and downward. The present invention is also intended to provide a method for use of the device. The device itself consists of a pair of jaws suitably configured to grasp one or more pages of a calendar therebetween, with the jaws biased towards each other by a biasing mechanism. The biasing mechanism can be overcome by a user to allow for the jaws to be opened, to permit removal of the calendar and to allow for the pages of the calendar to be changed. The front side of the device comprises a design element which is aesthetically pleasing. The rear side of the device comprises an attachment element allowing the device to be attached to a wall.

### DESCRIPTION OF THE DRAWINGS

FIG. 1 depicts a perspective view of one embodiment of the present invention, showing the frontal design element in ghost lines so that the other elements remain visible.

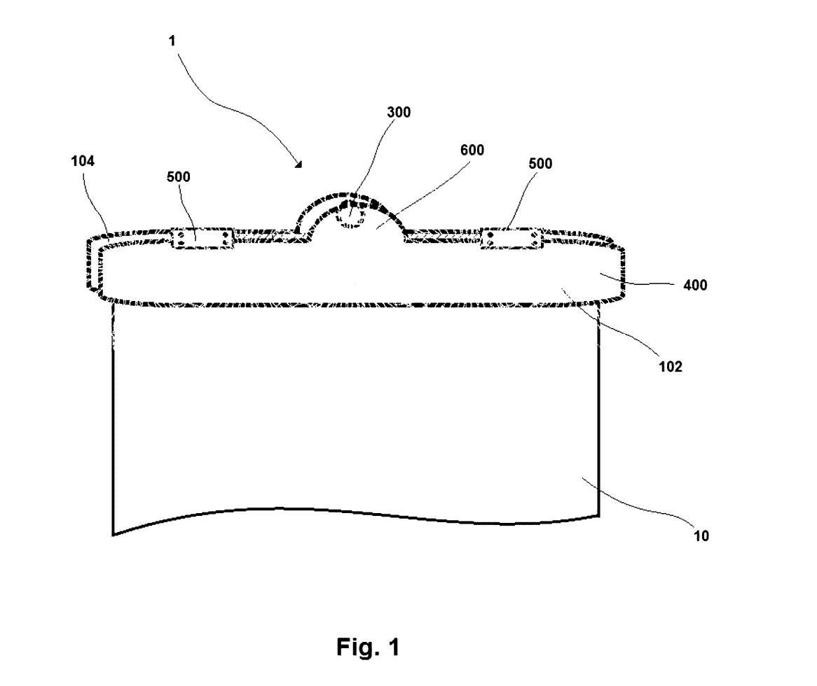

FIG. 2 depicts a perspective view of the embodiment of the present invention without the frontal design element to better depict other elements, including the spring and gripping member, shown in ghost line.

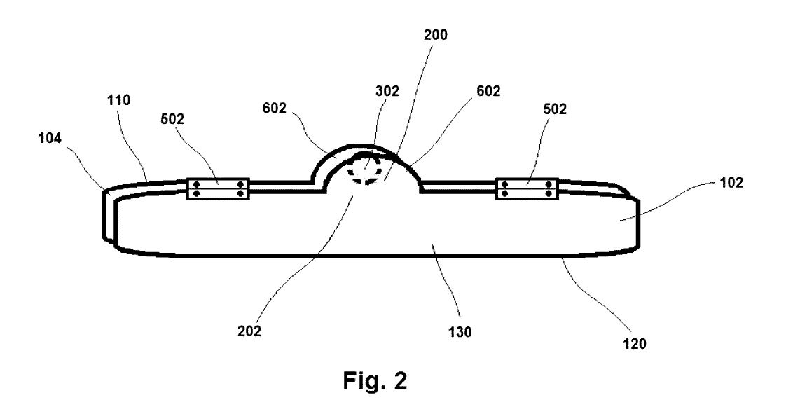

### DETAILED DESCRIPTION OF THE INVENTION

The device 1 of the present invention comprises a pair of jaws 102,104, a biasing mechanism 200, an attachment component 300, and a frontal design element 400.

Each jaw 102,104 of the pair of jaws is elongate, with a width, height, and thickness. The width of each jaw 102,104 is substantially greater than the height of each jaw 102,104, and the height of each jaw 102,104 is substantially greater than the thickness of each jaw 102,104. In the preferred embodiments, the widths of the jaws 102,104 are substantially the same as the width of a typical calendar 10, though they may be somewhat shorter or longer. For example, the widths of the jaws 102,104 may be between ten and fourteen inches. The heights of the jaws 102,104 may be between a quarter inch to two inches. The thicknesses may be between a tenth of an inch and a quarter inch. Each of the pair of jaws 102,104 is substantially rectangular in shape. The pair of jaws 102,104 is constructed of a substantially rigid material, such as plastic or wood or metal. Preferably, each of the jaws 102,104 is configured and sized the same as the other, though asymmetrical jaws may also be used.

The pair of jaws 102,104 is positioned during use in a substantially horizontal orientation. Thus, one edge of each jaw 102,104 along the widths of the jaws 102,104 is a top edge 110 and the opposite edge of each jaw 102,104 along the widths of the jaws 102,14 is a bottom edge 120. One of the jaws 104 is positioned proximate to the wall during use, and is designated the rear jaw 104. The other jaw 102 is designated the front jaw 102.

The jaws 102,104 are hingedly attached to each other proximate to their top edges 110. As such, the bottom edges 120 of the jaws 102,104 may be moved towards and away from each other. Any type of hinge mechanism 500 may be used to hingedly attach the jaws 102,104 to each other. For example, a single hinge 502 centered on the top edges 110 of the jaws 102,104 may be used; a pair of hinges 502 disposed on either end of the top edges 110 of the jaws 102,104 may be used; multiple hinges 502 disposed all along the top edges 110 of the jaws 102,104 may be used, etc.

Each jaw 102,104 may have a gripping member 130 located proximate to its bottom edge 120. The gripping members 130 of the jaws 102,104 are oriented such that when the bottom edges 120 of the jaws 102,104 are moved toward each other the gripping members 130 of the jaws 102,104 come in contact with each other. The gripping members 130 are suitably configured to contact the pages of the calendar 10 and to provide a greater securing means, either through increased friction or by mechanical grippers. In one embodiment the gripping members 130 may be elongate rubber strips. In another embodiment the gripping members 130 may be a plurality of rubber nubs. In yet another embodiment the gripping members 130 may be teeth formed into the bottom edges 120 of the jaws 102,104, with the teeth of the front jaw 102 disposed toward the teeth of the rear jaw 104.

The biasing mechanism 200 of the device 1 is configured to move the bottom edges 120 of the jaws 102,104 toward each other. The biasing mechanism 200 may be any configuration known in the art which accomplished this function. In the preferred embodiments, the biasing mechanism 200 comprises one or more springs 202. The biasing mechanism 200 should exert sufficient force on the jaws 102,104 so that when one or more pages of the calendar 10 are inserted between the jaws 102,104 they are securely held between the jaws 102,104. In some embodiments the biasing mechanism 200 is integrated with the hinge 502.

The device 1 also may have an anti-biasing element 600. That is, an element to assist the user is overcoming the bias of the biasing mechanism 200. In the preferred embodiments the anti-biasing element 600 comprises a pair of flanges 602 extending vertically from the tops of the jaws 102,104, one flange 602 per jaw. The flanges 602 are aligned with each other. The flanges 602 may be separate structures affixed to the jaws 102,104, or may be monolithic components formed from the jaws 102,104 themselves. When the distal ends of the flanges 602 are moved towards each other by the user, the biasing mechanism 200 is overcome and the bottom edges 120 of the jaws 102,104 move apart from each other. Once the user removes the force from the flanges 602 the biasing mechanism 200 returns the bottom edges 120 of the jaws 102,104 towards each other and the distal ends of the flanges 602 move apart from each other. The pair of flanges 602 may be centered on the device 1. Alternatively, they may be positioned at one end of the jaws 102,104. In another embodiment, two pair of flanges 602 may be used, with one pair located on one side of the jaws 102,104 and another pair located on the other side of the jaws 102,104. The flanges 602 themselves may have any shape that will be conducive to manipulation by a human hand. They may be rectangular, semi-circular, triangular, or any other suitable shape. Though the flanges 602 need not be the same shape, in the preferred embodiments they are configured and sized the same.

The device 1 comprises an attachment component 300 suitably configured to secure the device 1 to a wall. The attachment component 300 may be one or more apertures 302 formed through the rear jaw 104, allowing a corresponding number of nails or thumb tacks to pass therethrough and into the wall. Alternatively, a hook and loop fastener, such as Velcro™, can be used, with one half of the hook and loop fastener affixed to the rear jaw 104 and the other half affixed to the wall. Double sided adhesive tape may be affixed to the rear jaw 104. One or more hooks may be formed into the rear jaw 104. For use with metal walls, one or more magnets may be affixed to the rear jaw 104.

In the preferred embodiment, the device 1 has an anti-biasing element 600 comprised of a single pair of flanges 602 centered on the jaws 102,104, with the attachment component 300 being formed into the flange 602 attached to the rear jaw 104. Thus, an aperture 302 may be formed through the rear flange 602, or the hook and loop fastener may be affixed to the rear flange 602, or the double sided adhesive tape, or the magnet.

The device 1 further comprises a design element 400 located on the front jaw 102. The frontal design element 400 may be a separate structure affixed to the front jaw 102 or a monolithic component formed from the front jaw 102 itself. The frontal design element 400 may be anything that lends aesthetics to the device 1. It may be pictorial or sculptural and may be monochromatic or polychromatic. The frontal design element 400 should cover a substantial portion of the front jaw 102. In some embodiments the frontal design element 400 has a width greater than the width of the front jaw 102 and a height greater than the height of the front jaw 102 so as to completely hide the front jaw 102. However, the frontal design element 400 should not be so large as to obscure significant portions of the calendar 10.

The frontal design element 400 may be chosen to coincide with the photograph or artwork depicted on the calendar 10. For example, the frontal design element 400 may include drawings or sculptural renditions of flowers if the device 1 is intended to be used with a calendar 10 featuring photographs of flowers. (This feature is likely to be exploited by calendar manufacturers who will provide the device 1 with an appropriate frontal design element 400 together with the calendar 10.) Other design features may include depictions of animals, such as a bas relief of a crouching cat, a drawing of dog, a sculptural rendition of a coral reef with fish; or holiday themes, such as Christmas presents or Halloween pumpkins or a Thanksgiving cornucopia; or natural elements such as a tree with exposed roots, or vegetables, or fruits. The designs that may be included in the frontal design element 400 are limited only by the imagination.

The frontal design element 400 may be a removable component, so that different frontal design elements 400 can be used with the device 1. For example, a plurality of seasonal themed frontal design elements 400 may be used with the device 1, with a different frontal design element 400 used corresponding to the season shown on the calendar 10.

The present invention also discloses various methods of use of the device 1. The first method of use involves initial installation of the device 1 onto a wall. The method comprises the following steps:

Step A: obtain the device 1 disclosed herein; and

Step B: secure the device 1 to a wall using the attachment component 300 of the device 1.

Where hook and loop fasteners are used, or where one or more nails or screws are used to secure the device 1 to the wall, an additional step may be performed:

Step A1: prepare the wall for attachment of the device 1.

Step A1 may involve sticking one half of a hook and loop fastener to the wall by an adhesive, or inserting the one or more nails or screws into the wall. Step A1 may be performed before or after Step A, but must be performed before Step B.

The second method of use involves installation of a calendar 10 into the device 1.

The method comprises the following steps:

Step A: obtain the device 1 disclosed herein;

Step B: obtain a calendar 10;

Step C: select the page of the calendar 10 to be displayed;

Step D: manipulate the device 1 to overcome the biasing mechanism 200, thereby causing the bottom edges 120 of the jaws 102,104 to move apart; manipulation may be accomplished by utilizing the anti-biasing mechanism 600, if present;

Step E: position the top edge of the calendar 10 between the jaws 102,104 of the device 1; and

Step F: allow the biasing mechanism 200 of the device 1 to return the bottom edges 120 of the jaws 102,104 towards each other, thereby securing the top edge of the calendar 10 between the jaws 102,104.

Steps A and B may be performed in any order relative to each other; Steps C and D may be performed in any order relative to each other, though Step C must be performed after Step B and Step D must be performed after Step A; Step E must be performed after Step D and Step F must be performed after Step E.

The first and second methods may be combined, whereby all of the steps of the second method are performed during Step A of the first method.

The third method of use involves changing the calendar page of a calendar 10 previously installation into the device 1. The method comprises the following steps:

Step A: manipulate the device 1 to overcome the biasing mechanism 200, thereby causing the bottom edges 120 of the jaws 102,104 to move apart; manipulation may be accomplished by utilizing the anti-biasing mechanism 600, if present;

Step B: remove the calendar 10 from between the jaws 102,104 of the device 1;

Step C: allow the biasing mechanism 200 of the device 1 to return the bottom edges 120 of the jaws 102,104 towards each other;

Step D: select a different page of the calendar 10 to be displayed;

Step E: manipulate the device 1 to overcome the biasing mechanism 200, thereby causing the bottom edges 120 of the jaws 102,104 to move apart; manipulation may be accomplished by utilizing the anti-biasing mechanism 600, if present;

Step F: position the top edge of the calendar 10 between the jaws 102,104 of the device 1; and

Step G: allow the biasing mechanism 200 of the device 1 to return the bottom edges 120 of the jaws 102,104 towards each other, thereby securing the top edge of the calendar 10 between the jaws 102,104.

Step B must be performed after Step A; Step D must be performed after Step B; Step F must be performed after Step D; and Step G must be performed after Step F. Steps C and E may be eliminated, such that the biasing mechanism 200 remains overcome during Step D.

Modifications and variations can be made to the disclosed embodiments of the device 1 without departing from the subject or spirit of the invention.

1. A device for attaching a calendar to a wall, whereby said calendar is constructed of multiple pages and having a horizontal fold, with a photograph or other artwork presented above the horizontal fold and a rendering of days presented below the fold, said device comprising
a pair of jaws, comprising a front jaw and a rear jaw,
with the front jaw being elongate and having a width, height, and thickness, and constructed of a substantially rigid material, and having a top edge running along the width of said front jaw and a bottom edge running along the width of said front jaw located opposite of said top edge of said front jaw, and
with the rear jaw being elongate and having a width, height, and thickness, and constructed of a substantially rigid material, and having a top edge running along the width of said rear jaw and a bottom edge running along the width of said rear jaw located opposite of said top edge of said rear jaw, whereby said rear jaw is positioned proximate to the wall during use,
wherein the front and rear jaws are hingedly attached to each other proximate to their top edges such that the bottom edges of the jaws are capable of being moved towards and away from each other;
a biasing mechanism,
said biasing mechanism configured to move the bottom edges of the jaws toward each other, with the biasing mechanism capable of exerting sufficient force on the jaws to securely hold the calendar within the jaws when one or more pages of the calendar are inserted between the jaws;
an attachment component, wherein the attachment component is suitably adapted to secure the device to a wall; and
a frontal design element, said frontal design element located on the front jaw.

2. The device of claim 1 wherein
the width of each jaw is substantially greater than the height of each jaw, the height of each jaw is substantially greater than the thickness of each jaw, the width of each jaws is substantially the same as the width of the other jaw and substantially the same as a width of the calendar, with each of the pair of jaws being substantially rectangular in shape.

3. The device of claim 1 wherein the front and rear jaws are hingedly attached to each other by a hinge mechanism.

4. The device of claim 3 wherein the hinge mechanism comprises one or more hinges located along the top edges of the jaws.

5. The device of claim 1 wherein
each jaw has a gripping member located proximate to its bottom edge, said gripping members being suitably configured to contact pages of the calendar when the bottom edges of the pair of jaws are moved towards each other.

6. The device of claim 5 wherein each gripping member is one or more of the following group: an elongate rubber strip, a plurality of rubber nubs, and a plurality of teeth formed into the bottom edge of one a jaw with the teeth of each jaw disposed toward the teeth of the other jaw.

7. The device of claim 1 wherein the biasing mechanism comprises one or more springs.

8. The device of claim 3 wherein the biasing mechanism is integrated with the hinge mechanism.

9. The device of claim 1 wherein the attachment component is comprised of one of the following group: one or more apertures formed through the rear jaw with each such aperture each suitably adapted to allow a fastener to pass therethrough and into the wall, a hook and loop fastener with one half of said hook and loop fastener affixed to the rear jaw and the other half of the hook and loop fastener affixed to the wall, double sided adhesive tape which is affixed to the rear jaw, one or more hooks formed into the rear jaw, and one or more magnets affixed to the rear jaw.

10. The device of claim 1 wherein the frontal design element is a separate structure affixed to the front jaw.

11. The device of claim 1 wherein the frontal design element is a monolithic component formed from the front jaw.

12. The device of claim 1 wherein the frontal design element has a width greater than the width of the front jaw and a height greater than the height of the front jaw.

13. The device of claim 1 wherein the frontal design element is removably attached to the front jaw.

14. The device of claim 13 wherein the frontal design element comprises multiple design components, with each design component having a different appearance than that of each other design component.

15. The device of claim 1 further comprising an anti-biasing element, said anti-biasing element configured to move the bottom edges of the jaws away from each other.

16. The device of claim 15 wherein the anti-biasing element is comprised of a pair of flanges extending vertically from the top edges of the jaws, one flange per jaw, whereby movement of the flanges towards each other causes the bottom edges of the jaws to move away from each other.

17. The device of claim 16 wherein the flanges are monolithic components formed from the jaws.

18. The device of claim 16 wherein the pair of flanges is centered on the device.

19. The device of claim 15 wherein the anti-biasing element is comprised of two pairs of flanges extending vertically from the top edges of the jaws, two flanges per jaw, with one pair of flanges located proximate to one end of the jaws and another pair of flanges located proximate to another end of the jaws, whereby movement of the two flanges within a pair of flanges towards each other causes the bottom edges of the jaws to move away from each other.

20. The device of claim 16 wherein the attachment component is formed into the flange attached to the rear jaw.

21. A method for using a calendar holding device for attaching a calendar to a wall, whereby said calendar is constructed of multiple pages and having a top edge and a horizontal fold, with a photograph or other artwork presented above the horizontal fold and a rendering of days presented below the fold, and said calendar holding device comprises a pair of jaws, comprising a front jaw and a rear jaw, with the front jaw being elongate and having a width, height, and thickness, and constructed of a substantially rigid material, and having a top edge running along the width of said front jaw and a bottom edge running along the width of said front jaw located opposite of said top edge of said front jaw, and with the rear jaw being elongate and having a width, height, and thickness, and constructed of a substantially rigid material, and having a top edge running along the width of said rear jaw and a bottom edge running along the width of said rear jaw located opposite of said top edge of said rear jaw, whereby said rear jaw is positioned proximate to the wall during use, wherein the front and rear jaws are hingedly attached to each other proximate to their top edges such that the bottom edges of the jaws are capable of being moved towards and away from each other, a biasing mechanism, said biasing mechanism configured to move the bottom edges of the jaws toward each other, with the biasing mechanism capable of exerting sufficient force on the jaws to securely hold the calendar within the jaws when one or more pages of the calendar are inserted between the jaws, an attachment component, wherein the attachment component is suitably adapted to secure the device to a wall, and a frontal design element, said frontal design element located on the front jaw, said method comprising the following steps:
Step A: obtain the calendar holding device; and
Step B: secure the calendar holding device to a wall using the attachment component of the calendar holding device.

22. The method of claim 21 comprising the further step:
Step A1: prepare the wall for attachment of the calendar holding device,
wherein Step A1 may be performed in any order relative to Step A, but Step A1 must be performed before Step B.

23. The method of claim 21 comprising the further steps:
Step A1: obtain a calendar;
Step A2: select a page of the calendar to be displayed;
Step A3: manipulate the calendar holding device to overcome the biasing mechanism, thereby causing the bottom edges of the jaws to move apart;
Step A4: position the top edge of the calendar between the jaws of the calendar holding device; and
Step A5: allow the biasing mechanism to return the bottom edges of the jaws towards each other, thereby securing the top edge of the calendar between the jaws,
wherein Steps A and A1 may be performed in any order relative to each other; Steps A and A2 may be performed in any order relative to each other; Steps A2 and A3 may be performed in any order relative to each other; Step A2 must be performed after Step A1; Steps A3, A4, and A5 must be performed after Step A; Step A4 must be performed after Step A3; and Step A5 must be performed after Step A4.

24. The method of claim 23 comprising the further steps:
Step C: manipulate the calendar holding device to overcome the biasing mechanism, thereby causing the bottom edges of the jaws to move apart;
Step D: remove the calendar from between the jaws of the calendar holding device;
Step E: select a different page of the calendar to be displayed;
Step F: position the top edge of the calendar between the jaws of the device; and
Step G: allow the biasing mechanism to return the bottom edges of the jaws towards each other, thereby securing the top edge of the calendar between the jaws,
wherein Step C must be performed after Step B; Step D must be performed after Step C; Step E must be performed after Step D; Step F must be performed after Step E; and Step G must be performed after Step F.

25. The method of claim 23 comprising the further steps:
Step C: manipulate the calendar holding device to overcome the biasing mechanism, thereby causing the bottom edges of the jaws to move apart;
Step D: remove the calendar from between the jaws of the calendar holding device;
Step E: allow the biasing mechanism to return the bottom edges of the jaws towards each other;
Step F: select a different page of the calendar to be displayed;
Step G: manipulate the calendar holding device to overcome the biasing mechanism, thereby causing the bottom edges of the jaws to move apart;
Step H: position the top edge of the calendar between the jaws of the device; and
Step I: allow the biasing mechanism to return the bottom edges of the jaws towards each other, thereby securing the top edge of the calendar between the jaws,
wherein Step C must be performed after Step B; Step D must be performed after Step C; Step F must be performed after Step D; Step H must be performed after Step F; and Step I must be performed after Step H.
